(19) United States
(12) Patent Application Publication
(10) Pub. No.: US 2012/0211301 A1
(43) Pub. Date: Aug. 23, 2012

(54) PLATFORM LEVELING SYSTEM

(75) Inventors: Brian Clark, Seattle, WA (US); Rainer Leuschke, Seattle, WA (US); David Reed, Everett, WA (US)

(73) Assignee: GENIE INDUSTRIES, INC., Redmond, WA (US)

(21) Appl. No.: 13/031,879

(22) Filed: Feb. 22, 2011

(51) Int. Cl. B66F 11/04; G06F 19/00

(52) U.S. Cl. 182/2.2; 701/49

(57) ABSTRACT

A leveling system for a structure to be leveled is provided. At least one linear accelerometer is mounted to measure acceleration in a principal plane of motion of a lift structure. An angular rate sensor is mounted to measure angular velocity about an axis perpendicular to the principal plane of motion of the lift structure. An electronic control module is configured to use measurements from angular rate and accelerometer sensors to produce a level angle output. The level angle output is used to adjust and control a level angle of the structure to be leveled.

### BACKGROUND

1. Technical Field

The multiple embodiments disclosed herein relate to a leveling system for a vehicle with a structure to be leveled.

2. Background Art

A vehicle has a structure to be leveled, such as an aerial work platform or a telehandler fork. If the vehicle is an aerial work platform, it typically has a self propelled drive or unpowered ground chassis, a swing chassis, a boom lift structure and an operator platform. As the boom structure is deployed to lift the platform up and/or out, a reference angle of the joint supporting the platform changes. To maintain a level platform for the operator the joint angle has to be adjusted in sync with relevant boom lift functions.

The majority of aerial work platform models utilize master/slave leveling for the platform. The master/slave system typically has two hydraulic cylinders connected to the boom lift structure. A master cylinder is connected to a level reference on the primary pivot. A platform level cylinder is hydraulically connected in parallel to the master cylinder as a slave. As the master cylinder is extended the slave cylinder is retracted. The master/slave system does not work for lift structures without a level reference on the primary pivot, for example non-parallelogram 4-bar risers. Additionally the master/slave system adds weight and inefficiencies of the master cylinder, load holding valves and hydraulic hoses. The system inherently levels to the reference, which is generally the ground slope as it affects the drive chassis. Leveling to gravity is generally not possible. The master/slave system is subject to drift, the operator may manually adjust the platform to compensate.

Electronic platform leveling is a method that employs an angle sensor at the platform and generally a second sensor at the chassis. Hydraulic flow to the platform leveling cylinder is controlled to maintain the relative angle between chassis and platform. This is done to give the operator awareness of the ground level that the machine is operating on. Optionally the platform may be leveled to gravity. In order to level to gravity only the angle sensor at the platform is needed. The sensor employed to determine angle of the platform is conventionally accelerometer based. The sensor may measure acceleration in one or more directions. Gravity acceleration is sensed as a static component of total acceleration. A number of channels may be combined into a single angle measurement by vector addition depending on alignment of the axes of the accelerometer. The accelerometer cannot distinguish between short term accelerations of the platform due to propel or boom functions and changes in platform angle. A low pass filter is applied to the angle measurement to minimize the effects of this measurement error. The filter is designed to trade off smooth operation and stability with responsiveness and accuracy of the platform level control. The resulting performance limits of this system are generally detectable by the operator as lag in the level adjustment, undesirable adjustments when braking or accelerating and oscillations. The setup and tuning of the measurement algorithm is critical to achieve reasonable performance. This method is implemented on a number of aerial work platforms and vehicles. A vehicle with a telehandler fork operates similarly to an aerial work platform for leveling the telehandler fork.

The platform level cylinder is generally controlled by a proportional flow control and directional valves. To ensure safety a set of counterbalance valves is located at the cylinder.

### SUMMARY

In at least one embodiment, a leveling system for a vehicle with a structure to be leveled is disclosed. The leveling system has at least one linear accelerometer mounted to measure platform acceleration in at least one principal plane of motion of a lift structure, an angular rate sensor mounted to measure angular velocity about an axis perpendicular to the principal plane of motion of the lift structure, and an electronic control module configured to use measurements from angular rate and accelerometer sensors to produce a level angle output. The level angle output is used to adjust and control the angle of a structure to be leveled.

In another embodiment, a leveling system for a vehicle with a lift structure is disclosed. A linear accelerometer is mounted to measure acceleration of a lift structure to be leveled in a principal plane of motion of the lift structure. An angular rate sensor is mounted to measure angular velocity of the structure to be leveled about an axis perpendicular to the principal plane of motion of the lift structure. An electronic control module is configured to use measurements from angular rate and accelerometer sensors to produce a level angle output. The level angle output is used to adjust and control the angle of the structure to be leveled. The electronic control module updates a first compensated angle to a subsequent compensated angle by adding a product of loop time and angular rate to a first compensated angle. The compensated angle is compared to a low pass filtered accelerometer based angle to produce a resulting error. The resulting error adjusts the compensated angle to the level angle output which approaches the accelerometer based angle using a compensation coefficient.

In yet another embodiment, a method of leveling a lift structure is disclosed. The method includes providing a linear accelerometer mounted to measure acceleration in a principal plane of motion of a lift structure, providing an angular rate sensor mounted to measure angular velocity about an axis perpendicular to the principal plane of motion of the lift structure, and providing an electronic control module configured to use measurements from angular rate and accelerometer sensors to produce a level angle output. The level angle output is used to adjust and control the angle of the lift structure.

### BRIEF DESCRIPTION OF THE DRAWINGS

FIG. 1 is a side elevation view of a vehicle including an aerial work platform leveling system in accordance with an embodiment of the present disclosure;

FIG. 2 is a partial view of the aerial work platform leveling system of FIG. 1;

FIG. 3 is a perspective view of an aerial work platform sensor module in accordance with at least one embodiment of the present disclosure;

FIG. 4 is a block diagram illustrating dynamic angle compensation in accordance with at least one embodiment of the present disclosure;

FIG. 5 is a block diagram illustrating an estimation of a dynamic angular rate in accordance with at least one embodiment of the present disclosure;

FIG. 6 is a partial view of a vehicle including an aerial work platform leveling system in accordance with another embodiment of the present disclosure; and

FIG. 7 is a partial view of a vehicle including a material lift leveling system in accordance with yet another embodiment of the present disclosure.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the disclosed embodiments.

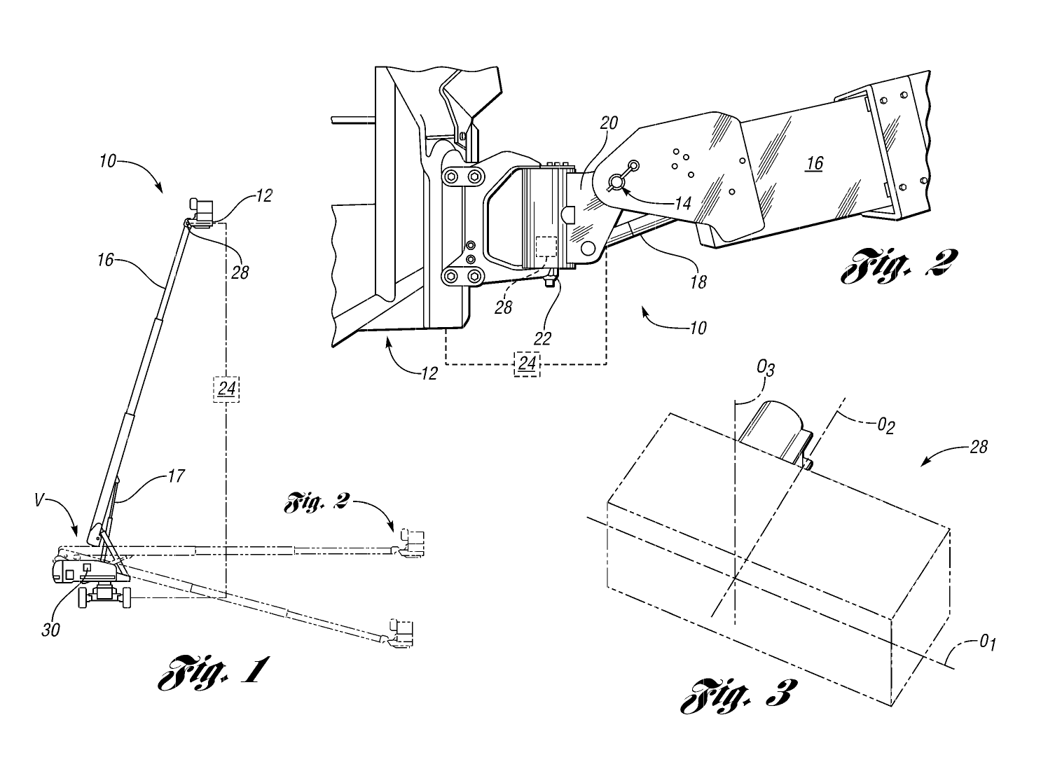

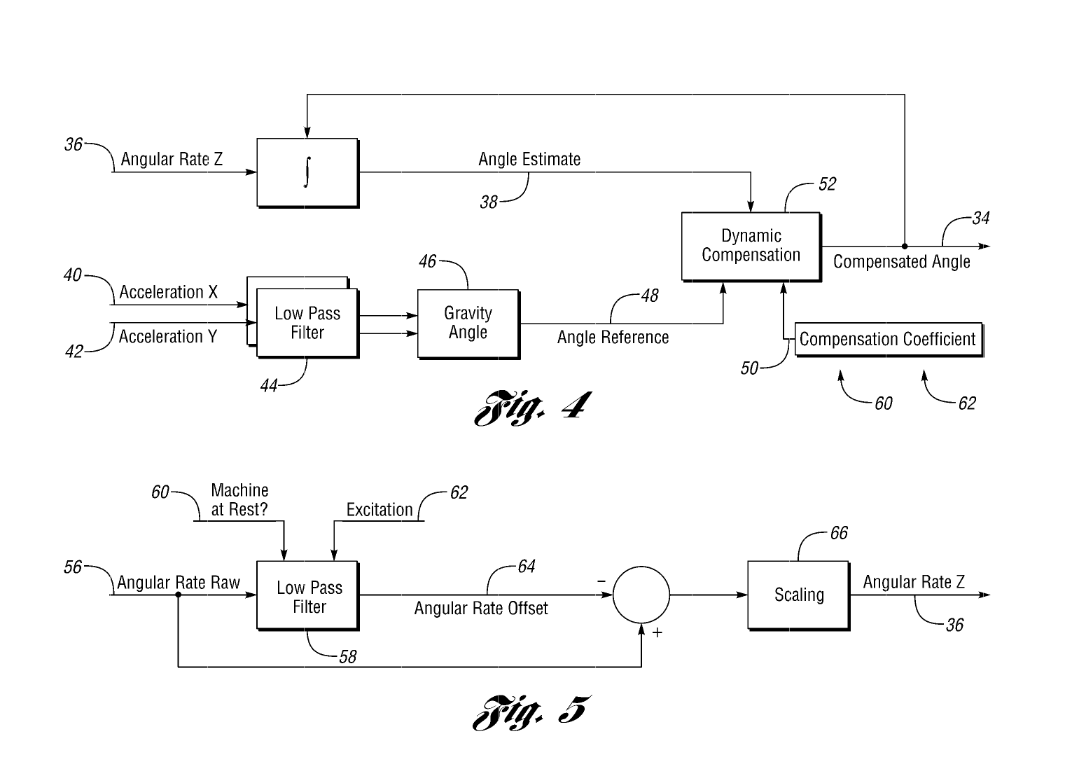

With reference now to FIGS. 1-2, a platform leveling system 10 on a vehicle V is generally illustrated. The vehicle V may generally be referred to as an aerial work platform assembly. The platform leveling system 10 has an operator platform 12 that is connected directly or indirectly via a pivot 14 to the boom lift structure 16. The platform 12 may be an aerial work platform, a material lift, or other structures to be leveled with reference to a vehicle V. The platform 12 is moved using a primary lift cylinder 17. A platform leveling actuator 18 may be mounted to the pivot 14 to enable changes in angle of the platform 12 relative to the rest of the lift structure 16. The platform 12 may be connected to the boom lift structure 16 using a bell crank assembly 20 and the actuator 18. The platform 12 may be connected to the bell crank assembly 20 using a platform rotator 22, which may be hydraulically actuated to pivot the platform 12 with respect to the boom lift structure 16 without changing the level of platform 12. In at least one embodiment, the platform tilt actuator 18 is a hydraulic cylinder. The hydraulic cylinder 18 may be equipped with dual counterbalance valves or other load holding valves that can be controlled by directional and flow control valves in the platform manifold. Of course, any suitable platform leveling actuator 18 is contemplated within the scope of the disclosed embodiments. The platform leveling system 10 may have a machine controller 24 that operates the valves in accordance to manual operator, sensor and safety system input, as discussed further below.

The multiple embodiments disclosed herein include a first angle sensor module 28 and a second angle sensor module 30 that are utilized with an algorithm to combine several sensor readings into a stable and accurate measurement of the motion of the platform 12. Redundant sensor information can be used to diagnose sensor faults and/or enable safety modes that allow the operator to lower the platform 12 even when some of the sensing elements have been determined to be faulty. The first sensor module 28 and/or the second sensor module 30 may include rate sensors and/or accelerometers to obtain measurements for all six (6) degrees of freedom to enable determination of the full state of motion of the platform 12.

In at least one embodiment, the first angle sensor module 28 is mounted to a point referenced to inclination of the platform 12. The first angle sensor module 28 may be referred to as the platform referenced sensor 28. The second angle sensor module 30 may be mounted to a point referenced to the ground level, such as the chassis of the vehicle V. The second angle sensor module 30 may be referred to as the ground referenced sensor 30. Mounting positions of the first angle sensor module 28 and the second angle sensor module 30 may be chosen such that axes of each sensor 28, 30 remain aligned in any position of the lift structure 16 or alignment can be inferred from additional measurements. In an embodiment of a platform leveling system 10 having a swing chassis, the ground referenced sensor 30 will generally be on the swing chassis. The platform referenced sensor 28 can be located on a fixed side of a platform rotator 22 or jib rotator, if present.

An embodiment of the angle sensor module 28 is illustrated in FIG. 3. Although the first angle sensor module 28 is illustrated, the second angle sensor module 30 may be substituted for the first angle sensor module 28. The angle sensor module 28 contains a number of sensing elements. The measured entities are: linear acceleration along two orthogonal axes O1, O2 of the angle sensor module 28 and angular rate around an axis O3, orthogonal to the first two axes of the angle sensor module 28. The acceleration along the two orthogonal axes O1, O2 and the angular rate around an axis orthogonal to the first two axis O3 is the minimum information needed to fully describe motion in one plane. Of course, additional sensing elements may be used for redundancy and/or to account for out of plane motion, for example when the vehicle V of FIG. 1 is tilted to a side. The measurement plane is preferably aligned with the plane of motion of the platform 12 when actuated by the platform tilt actuator 18.

In another embodiment the linear acceleration may be measured along one or more non-orthogonal directions in the measurement plane and the results combined by vector addition to provide an in-plane acceleration measurement and direction. In other embodiments, sensor 28 may be replaced with multiple or separate sensor modules capable of providing similar data.

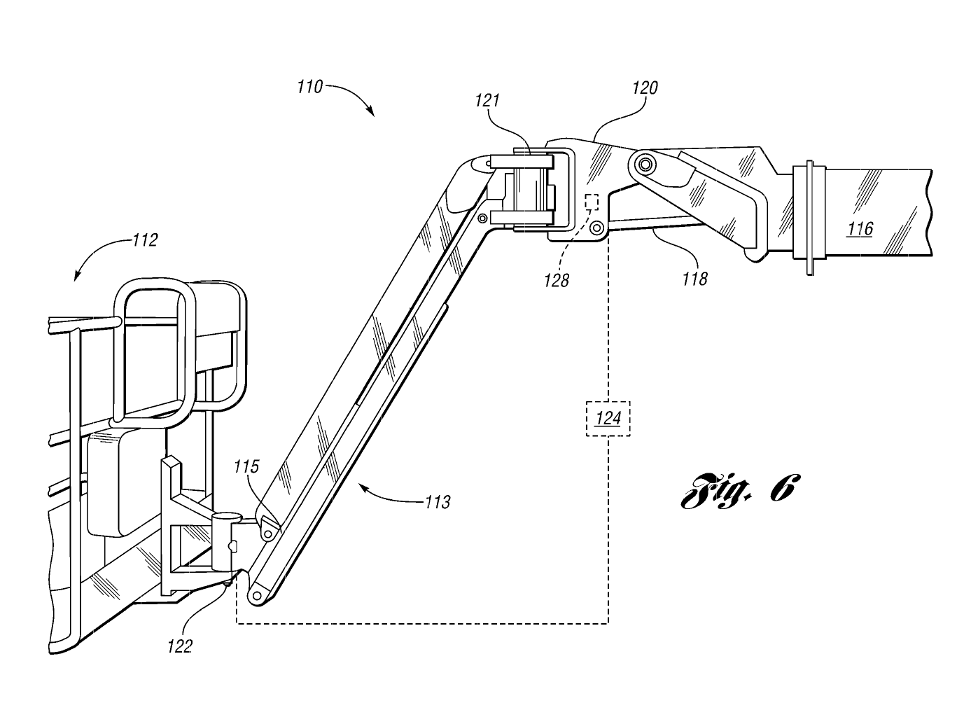

In one embodiment, an output of the angle sensor module 28 of the acceleration of the two orthogonal axes O1, O2 may be an accelerometer output. The accelerometer output can be used to determine an angle referenced to gravity. The measurement of the angle sensor module 28 is a static measurement so that the accelerometer output is stable over a long term without intermittent service, but may be subject to error from transient linear accelerations of the angle sensor module 28. Another output of the angle sensor module 28 that is the angular rate around an axis O3 orthogonal to the first two axes may be the angular rate output. The angular rate output measures angular velocity of the angle sensor module directly, which can be numerically integrated to determine angle. The angular rate output of the angle sensor module 28 may be insensitive to linear accelerations and the integration process inherently reduces measurement noise and/or error. However, over the long-term small errors in sensor offset calibration can accumulate to a large error in the result. Effective and accurate offset calibration is therefore critical to measurement accuracy (see FIG. 4).

The illustrated platform leveling system 10 of FIG. 1, combines high dynamic accuracy of the angle measurement derived from the angular rate output and high stability of the angle measurement derived from the accelerometer output to obtain an angle measurement that is both accurate dynamically, long term stable and insensitive to linear accelerations. An algorithm to combine first sensor module 28 data into a single measurement, which may be referred to as the compensated angle, can be implemented in a dedicated electronic control module or the machine controller 24.

With reference to FIG. 4-5, a block diagram illustrating dynamic angle compensation 34 is provided. Angular rate 36 is obtained by the angle sensor module 28 measuring the raw angular rate 56 in one direction Z. The direction Z is normal to the main plane of the lift structure 16 movement. The angular rate 36 in the direction Z is numerically integrated with the compensated angle 34. In a first iteration, the compensated angle 34 is a predetermined number. In subsequent iterations, the compensated angle 34 is calculated. The output is the angle estimate 38.

Linear acceleration is measured by the accelerometer within the angle sensor module 28 as acceleration 40 in a first direction X and acceleration 42 in a second direction Y. The acceleration 40 in the first direction X and acceleration 42 in the second direction Y is then low pass filtered 44. A gravity angle 46 is calculated to produce an angle reference output 48.

In at least one embodiment, the accelerometer based gravity angle 46 is obtained from two orthogonally arranged accelerometers in the angle sensor module 28, 30. The angle may be calculated as alpha=arctan(ax/ay). This arrangement has the benefit that the result is relatively insensitive to calibration of the accelerometers. In the case of the failure of one of the accelerometer elements, the controller 24 may switch to a mode where the gravity angle 46 is calculated from a single accelerometer (alpha=arcsin(ax/g) or arccos(ay/g). This mode will allow safe descent for the operator with additional limitations (reduced velocity, descent only etc.). Similarly in case of failure of the angular rate sensor, a safe descent mode can be activated that will only use accelerometer based angles.

The angle estimate output 38 and the angle reference output 48 are both combined, along with a predetermined compensation coefficient 50 as a dynamic compensation 52. The output of the dynamic compensation 52 is the compensated angle 34.

Aerial work platform systems, such as the platform leveling system 10 illustrated in FIG. 1, spend significant portions of their operational time at rest, while work is being performed by an operator. The compensation coefficient 50 may be adjusted dynamically to reflect knowledge of the machine state to minimize measurement error. When the machine is at rest as determined by monitoring function switches and accelerometer excitation, the compensation coefficient 50 may be set to be relatively large to remove error from the compensated angle output 34 quickly. However, when the machine is moving in a highly dynamic environment and lift functions are being operated the compensation coefficient 50 may be selected to be small or even zero to reject error from the accelerometer based angle calculation to be injected into the compensated angle output 34.

In one embodiment, the angle reference output 48 is more accurate when the machine is not moving and inaccurate when the machine is moving due to non-vertical accelerations. The angle estimate 38 is precise during short term changes regardless of acceleration, but drifts over time. The two angles 38, 48 may be weighted to consider the vehicle control state from the vehicle control module 24. Since aerial work platforms, material lifts, and the like are inactive for much of the time, this approach is appropriate. The accelerometer based angle 48 is weighted when the underlying support structure is stationary and the angular rate 38 is weighted when the underlying support structure is in motion or shaking.

Referring now to FIG. 4, a block diagram depicting an estimation of a dynamic angular rate 36 is illustrated. A raw angular rate measurement 56 is provided by the angle sensor module 28 to a low pass filter 58 along with information indicating whether the vehicle V is at rest 60 and an accelerometer excitation measurement 62. When the vehicle V is at rest and dynamically unexcited the angular rate offset output 64 is updated. The angular rate offset 64 is subtracted from the raw angular rate measurement 56 and appropriate scaling 66 is applied to determine a compensated dynamic angular rate 36.

The platform leveling system 10 and method thereof provides for a generally lag-free and accurate angle measurement for the level of the platform 12. Generally lag-free angle measurement shall mean that there is generally not a delay between the occurrence of the angle and the measurement thereof. Of course, a small amount of time delay between the occurrence of the angle and the measurement thereof is to be expected but is minimized. The accuracy of the compensated angle 34 is principally limited by the calibration accuracy of angular rate offset 64. The angular rate offset 64 may, depending on the angle sensor module 28, 30, be sensitive to temperature and drift over time. To maintain accuracy of the calibration setpoint, the angular rate sensor offset 64 can be occasionally estimated and updated. The estimation algorithm may be based on but not limited to linear or advanced filtering methods, such as adaptive or Kalman filtering. In the current embodiment, heuristics are applied that are based on a rest state of the platform leveling system 10 and dynamics captured by the angle sensor module 28, 30 itself. When the platform leveling system 10 is static, as determined by monitoring function switches and inertial sensor excitation, the angular rate sensor output 56 is low pass filtered and the result used to update the sensor offset 64. The time constant of the low pass filter is optimized to match the noise characteristics of the sensor element. This approach ensures that a slow drift in offset is captured while external excitations are not allowed to distort the result.

The compensation coefficient 50 may be determined using information indicating whether the vehicle V is at rest 60, and an accelerometer excitation measurement 62. The machine motion input 60 may be provided by a motion sensor, a vehicle control module, or be based on user inputs, such as engaging a drive transmission, engaging a park function, or actuating the vehicle accelerator or parking brake or the like. The accelerometer excitation measurement 62 may be provided by accelerometers measuring vibratory or other shaking motion of the vehicle V or from an existing input such as acceleration 40, 42.

The same method of measurement may be applied to the platform referenced sensor 28 and the ground level referenced sensor 30. A conventional accelerometer only sensor may be used for the ground level referenced sensor because dynamics of the swing chassis are relatively low. Depending on user selectable options, the platform 12 may be controlled to be parallel to the ground under the vehicle V or level to gravity. Optionally, the operator may also manually trim the angle of the platform 12 to suit their preferences. Based on these inputs, a setpoint is calculated and used by the controller 24 to drive the output to the hydraulic valves and actuator 18. The controller 24 may use feedback from the angle sensor modules 28, 30 and feedforward information derived from other sensors, as well as monitoring the vehicle V state (joystick input, toggle switches) to determine an appropriate output command. The level of the platform 12 can be controlled to optimize a variety of objectives such as, e.g. minimize error or minimize energy consumption and meet operator comfort and safety requirements.

Accurate knowledge of motion of the platform 12 in the boom plane also enables the enforcement of operational limits of the platform 12. Compliance with regulations can be ensured by limiting function speed for the worst case scenario. By using the speed of the platform 12, as derived from sensor measurements, the function speed can be adapted such that velocity is optimized through the motion range. This allows for faster time to height, while ensuring operator safety and comfort.

When compared to prior art, such as filtered accelerometer systems, the disclosed embodiments of the platform leveling system 10 for the vehicle V, can eliminate issues of delayed response, excessive error, hunting, sensitivity to linear accelerations, stability. Platform leveling can be enabled while driving, as well as extending the main boom and other functions that previously had to limit platform leveling because of their sensitivity to linear accelerations.

In addition, linear platform velocity can be determined directly and used for vehicle V control. The main application is to limit maximum linear speed of the platform 12 for operator safety without sacrificing speed in mechanically disadvantaged portions of the workspace.

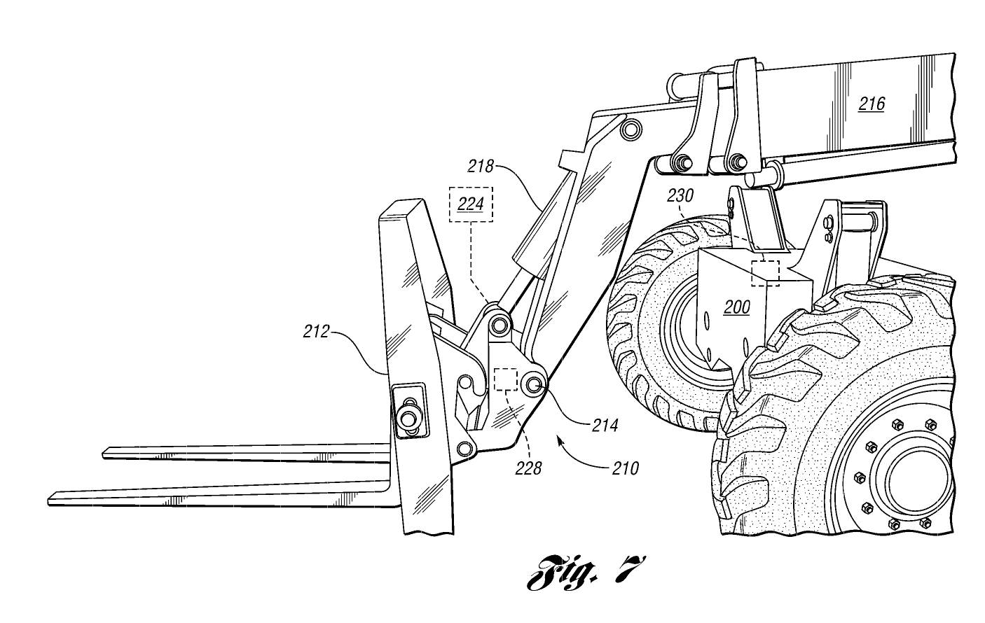

FIG. 6 illustrates another embodiment of a vehicle that may be equipped with a lift structure leveling system as described above. The vehicle 100 has a platform leveling system 110 with an operator platform 112 that is connected via a parallelogram jib 113 to the boom lift structure 116. A jib cylinder 115 may be mounted to the jib 113. A bell crank assembly 120 and level cylinder 118 connects the boom lift structure 116 to the jib 113. A platform rotator 122 may be hydraulically actuated to pivot the platform 112 with respect to the jib 113. A jib rotary actuator 121 may be hydraulically actuated to pivot the jib 113 with respect to the boom lift structure 116. In at least one embodiment, the jib cylinder 115 and the level cylinder 118 are hydraulic cylinders. The platform leveling system 110 may have a machine controller 124 that operates the actuators in accordance to manual operator, sensor and safety system input, as discussed previously. A first angle sensor module 128, and in some embodiments, a second angle sensor module (not shown), are utilized with an algorithm to combine several sensor readings into a stable and accurate measurement of the motion of the platform 112. The second angle sensor module (not shown) may be mounted to a point referenced to the ground level, such as the chassis of the vehicle 110. The platform 112 is controlled to be level using the algorithms discussed above with respect to FIGS. 2-4.

FIG. 7 illustrates yet another embodiment of a vehicle that may be equipped with a lift structure leveling system as described above. The vehicle 200 has a fork frame leveling system 210 with a material lift structure 212 that is connected via a pivot 214 to the boom lift structure 216. A level cylinder 218 connects the boom lift structure 216 to the material lift 212. In at least one embodiment, level cylinder 218 is a hydraulic cylinder. The platform leveling system 210 may have a machine controller 224 that operates the actuators in accordance to manual operator, sensor and safety system input, as discussed previously. A first angle sensor module 228, and in some embodiments, a second angle sensor module 230, are utilized with an algorithm to combine several sensor readings into a stable and accurate measurement of the motion of the material lift 212. The material lift 212 is controlled to be level using the algorithms discussed above with respect to FIGS. 2-4.

While embodiments disclosed herein have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A leveling system for a vehicle with a structure to be leveled, the leveling system comprising:
at least one linear accelerometer mounted to measure platform acceleration in at least one principal plane of motion of a lift structure;
an angular rate sensor mounted to measure angular velocity about an axis perpendicular to the principal plane of motion of the lift structure; and
an electronic control module configured to use measurements from angular rate and accelerometer sensors to produce a level angle output;
wherein the level angle output is used to adjust and control a level angle of a structure to be leveled.

2. The leveling system of claim 1 further comprising:
a pivot adapted to be mounted to the structure to be leveled and a boom lift structure to allow movement of the structure to be leveled; and
a tilt actuator mounted near the pivot to enable changes in angle of the structure relative to an underlying support surface;
wherein the structure to be leveled is adapted to be connected to the lift structure.

3. The leveling system of claim 2 further comprising a second angular sensor module mounted such that it is referenced to the underlying support surface of the structure to be leveled.

4. The leveling system of claim 2 wherein the tilt actuator further comprises a hydraulic cylinder.

5. The platform leveling system of claim 4 wherein the hydraulic cylinder further comprises load holding valves.

6. The leveling system of claim 1 wherein an angle relative to gravity is determined from a measurement of acceleration and angular rate.

7. The leveling system of claim 1 wherein the electronic control module further comprises a machine controller to operate hydraulic valves in accordance with at least one of manual operator and system inputs.

8. The leveling system of claim 1 wherein the electronic control module updates a first compensated angle to a subsequent compensated angle by adding a product of loop time and angular rate to the first compensated angle value, the subsequent compensated angle is compared to a low pass filtered accelerometer based angle to produce a resulting error, the resulting error adjusts the subsequent compensated angle to the level angle output which approaches the accelerometer based angle using a compensation coefficient.

9. The leveling system of claim 8 further comprising a motion sensor referenced to the underlying support structure to determine if the underlying support structure is in motion or stationary;
wherein the electronic control module updates the angle of the measured structure by proportionally using one of an input from the motion sensor and a vehicle control system;
wherein the accelerometer based angle is weighted when the underlying support structure is stationary and the angular rate is weighted when the underlying support structure is in motion or shaking.

10. A leveling system for a vehicle with a lift structure comprising:
a linear accelerometer mounted to measure acceleration of a lift structure to be leveled in the at least one principal plane of motion of the lift structure;
an angular rate sensor mounted to measure angular velocity about an axis perpendicular to the principal plane of motion of the lift structure; and
an electronic control module configured to use measurements from angular rate and accelerometer sensors to produce a lift structure level angle output;
wherein the level angle output is used to adjust and control a level angle; and
wherein the electronic control module updates a first compensated angle to a subsequent compensated angle by adding a product of loop time and angular rate to a first compensated angle, the compensated angle is compared to a low pass filtered accelerometer based angle to produce a resulting error, the resulting error adjusts the compensated angle to the platform level angle output which approaches the accelerometer based angle using a compensation coefficient.

11. The leveling system of claim 10 wherein the lift structure includes a platform adapted to be connected to a boom lift;
the leveling system further comprising a pivot adapted to be mounted to the platform and the boom lift structure to allow movement of the platform; and
a platform tilt actuator mounted to the pivot to enable changes in angle of the platform relative to an underlying support surface.

12. The leveling system of claim 11 wherein the platform tilt actuator further comprises a hydraulic cylinder.

13. The leveling system of claim 12 wherein the hydraulic cylinder further comprises load holding valves.

14. The leveling system of claim 10 wherein an angle relative to gravity is determined from a measurement of acceleration and angular rate.

15. The leveling system of claim 10 wherein the electronic control module further comprises a machine controller to operate hydraulic valves in accordance with at least one of manual operator and system inputs.

16. A method of leveling a lift structure comprising:
providing a linear accelerometer mounted to measure platform acceleration in a principal plane of motion of a platform of a lift structure;
providing an angular rate sensor mounted to measure angular platform velocity about an axis perpendicular to the principal plane of motion of the lift structure; and
providing an electronic control module configured to use measurements from angular rate and accelerometer sensors to produce a platform level angle output;
wherein the platform level angle output is used to adjust and control a platform level angle.

17. The method of claim 16 further comprising:
providing a pivot adapted to be mounted to the platform and a boom lift structure to allow movement of the platform; and
providing a platform tilt actuator mounted to the pivot to enable changes in angle of the platform relative to an underlying support surface.

18. The method of claim 17 further comprising providing a second angular sensor module mounted such that it is referenced to an underlying support surface of the lift structure to enable leveling of the structure relative to the underlying surface.

19. The method of leveling an aerial work platform of claim 18 wherein the platform tilt actuator further comprises a hydraulic cylinder.

20. The method of leveling an aerial work platform of claim 16 wherein the electronic control module updates a first compensated angle to a subsequent compensated angle by adding a product of loop time and angular rate to the first compensated angle value, the subsequent compensated angle is compared to a low pass filtered accelerometer based angle to produce a resulting error, the resulting error adjusts the subsequent compensated angle to the platform level angle output which approaches the accelerometer based angle using a compensation coefficient.
